(19) United States
(12) Patent Application Publication
(10) Pub. No.: US 2005/0172057 A1
(43) Pub. Date: Aug. 4, 2005

(54) System for controlling connection of disk devices

(75) Inventors: Hiroshi Suzuki, Yokohama (JP); Katsuhisa Miyata, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/814,475

(22) Filed: Mar. 30, 2004

(30) Foreign Application Priority Data
Jan. 29, 2004 (JP) 2004-021181

(51) Int. Cl. G06F 13/00

(52) U.S. Cl. 710/74; 711/112

(57) ABSTRACT

An object of the present invention is to intensity protection of data in a disk device that is shared by a plurality of computers or a plurality of programs. According to the present invention, a connection control program handles input or output from or to a logical volume. An input/output execution control block references a connection information definition block to retrieve a connected state value concerning the connection of an input/output request source computer to an object logical volume or an object logical area. The input/output execution control block then judges whether input or output from or to the logical volume or logical area is enabled. If input or output is enabled, input or output from or to the object logical volume or logical area is executed. If input or output is disabled, input or output is not executed. A definition implementor included in a computer specifies connection information, which is employed by the input/output execution control block, in the connection information definition block. The connection information maybe specified the connection information definition block using a definition implementor included in a disk control unit. The connection information recorded in a definition file may be specified in the connection information definition block.

### BACKGROUND OF THE INVENTION

The present invention relates to a technology for connecting a disk device to a computer system.

In recent years, the scale of disk devices has come to be large along with the trend to larger-scale computer systems or an increase in an amount of processed data. A configuration in which a plurality of computers shares the same disk device is prevailing.

Moreover, the awareness that security for data to be treated by a computer system must be intensified has been deepened. When a plurality of computers shares a disk device, whether each of the computers can access each of volumes is determined for operation of the computer system in many cases. In these cases, a method disclosed in, for example, Japanese Patent Laid-Open No. H10(1998)-333839 is adaptable. The literature has disclosed a storage control system including a control table that is used to manage disk array system storage areas (logical areas or logical units (LU)).

Furthermore, more and more computer systems are being operated around the clock due to globalization of business or an increase in a service time. In many cases, if a normally operating computer system fails, the computer system is taken over by an auxiliary computer system during a short period of time so that jobs can be continuously processed. The operating computer system and auxiliary computer system share the same disk device so that the auxiliary computer system can succeed to job data. When the systems are switched, connections to the disk devices must be switched. In order to switch the connections, hardware called a director or a switch is generally employed.

### SUMMARY OF THE INVENTION

In order to switch the connections of a disk device, which is shared by a plurality of computer systems, while the computer systems are in operation and application programs are unaware of the fact, dedicated hardware called a director or a switch must be used to physically connect or disconnect input/output paths linking the computer systems and the disk device. Consequently, the cost of introducing the hardware is needed.

Moreover, according to the ongoing technology for controlling whether each computer can access each of logical volumes included in a disk device, limitations are imposed on the configuration or operation of a computer system in terms of data protection. For example, a security level may differ from program to program or from data to data. In this case, according to a system in which whether each computer accesses each logical volume, an operation form in which a computer system is operated cannot be determined in fine detail. Therefore, the system is not user-friendly. If logical volumes are finely defined in efforts to improve the freedom in operation, the number of logical volumes increases and control becomes complex.

Moreover, assume that an operation form is such that types of jobs to be processed by a computer are switched with the start of each of different time zones, and kinds of data to be treated simultaneously are differentiated in association with the time zones. In the operation form, volumes or files that are accessible must be able to be switched with the start of each of the time zones for the purpose of data protection. Thus, restrictions are imposed on usage of a computer system.

Accordingly, an object of the present invention is to provide a connection control system for controlling connection of a disk device that offers great freedom in usage of a computer system in whichever of various operation forms the computer system is used and that ensures high-level data protection.

Another object of the present invention is to provide a connection control system for controlling connection of a disk device that intends to reduce the cost of operating a computer system around the clock and also intends to intensity data protection.

According to a constituent feature of the present invention, an input/output management system for managing input or output from or to a disk device connected to a computer comprises: a connection information definition block that defines the relationship of logical connection between the computer and a logical volume included in the disk device or between the computer and a logical area in a logical volume; and an input/output execution control block that controls based on the definition whether the computer can access a logical volume included in the disk device or a logical area in a logical volume.

According to other constituent feature of the present invention, an input/output management system for managing input or output from or to a disk device connected to a plurality of computers comprises: a connection information definition block that defines based on computer identification information the relationship of logical connection between each of the computers and a logical volume included in the disk device or between each of the computers and a logical area in a logical volume; and an input/output execution control block that controls based on the definition whether to each of the computers can access a logical volume included in the disk device or a logical areas in a logical volume.

The relationship of logical connection between each of the computers and a logical area in a logical volume included in the disk device may be defined using port numbers assigned to the ports of the disk device connected to the computers. The relationship of logical connection between each of the computers and a logical area in a logical volume included in the disk device may be defined using computer identification information. More particularly, a host identifier that is appended to an input/output request issued from a computer may be used to identify the computer that has issued an input/output request. On the other hand, a connected state value indicating whether each computer can access a logical volume or a logical area is defined as volume connection information. A plurality of pieces of volume connection information is held in the disk device, and one of the pieces of volume connection information is employed according to a condition.

According to the present invention, data in a disk device can be protected irrespective of in which of various operating forms a computer system is used. Specifically, since not only logical volumes but also logical areas in the logical volumes are accessible, freedom in operation is ensured without an increase in the number of volumes. Moreover, high-level data protection is achieved. Otherwise, an accessible volume or file is determined for each of a plurality of computers or a plurality of application programs, whereby user-friendliness is improved and data protection is intensified. Moreover, the connections of the disk device can be switched by software. Compared with the related art requiring employment of dedicated hardware, the present invention can reduce a cost.

### BRIEF DESCRIPTION OF THE DRAWINGS

FIG. 1 shows a system configuration including an embodiment of the present invention;

FIG. 2 shows the detailed configuration of a connection control program shown in FIG. 1;

FIG. 3 shows the detailed structure of logical volume connection information shown in FIG. 2;

FIG. 4 shows the detailed structure of a schedule definition division shown in FIG. 2;

FIG. 5 shows the detailed structure of a computer identification information definition division shown in FIG. 2;

FIG. 6 shows the detailed structure of a computer succession information definition division shown in FIG. 2;

FIG. 7 shows concrete examples of definitions made by a connection information definition block shown in FIG. 2;

FIG. 8 is a flowchart describing a process of controlling whether input or output is enabled which is executed by a connection control program shown in FIG. 1;

FIG. 9 is a flowchart describing the details of a process of judging whether input or output is enabled which is described in FIG. 8;

FIG. 10 is a flowchart describing the details of updating the connection information definition block which is described in FIG. 8;

FIG. 11 is a flowchart describing the flow of schedule control;

FIG. 12 shows a configuration of an embodiment that controls whether input or output from or to a logical volume connected to a plurality of computers is enabled;

FIG. 13 shows a configuration of an embodiment that controls whether input or output from or to a logical volume shared by a plurality of programs is enabled;

FIG. 14 shows a configuration of an embodiment in which online jobs and batch jobs are processed during different time zones; and

FIG. 15 shows a configuration of an embodiment in which a connection control program is installed in a computer.

### DESCRIPTION OF THE PREFERRED EMBODIMENTS

Referring to the drawings, embodiments of an input/output management system for managing input or output from or to a disk device in accordance with the present invention will be described below.

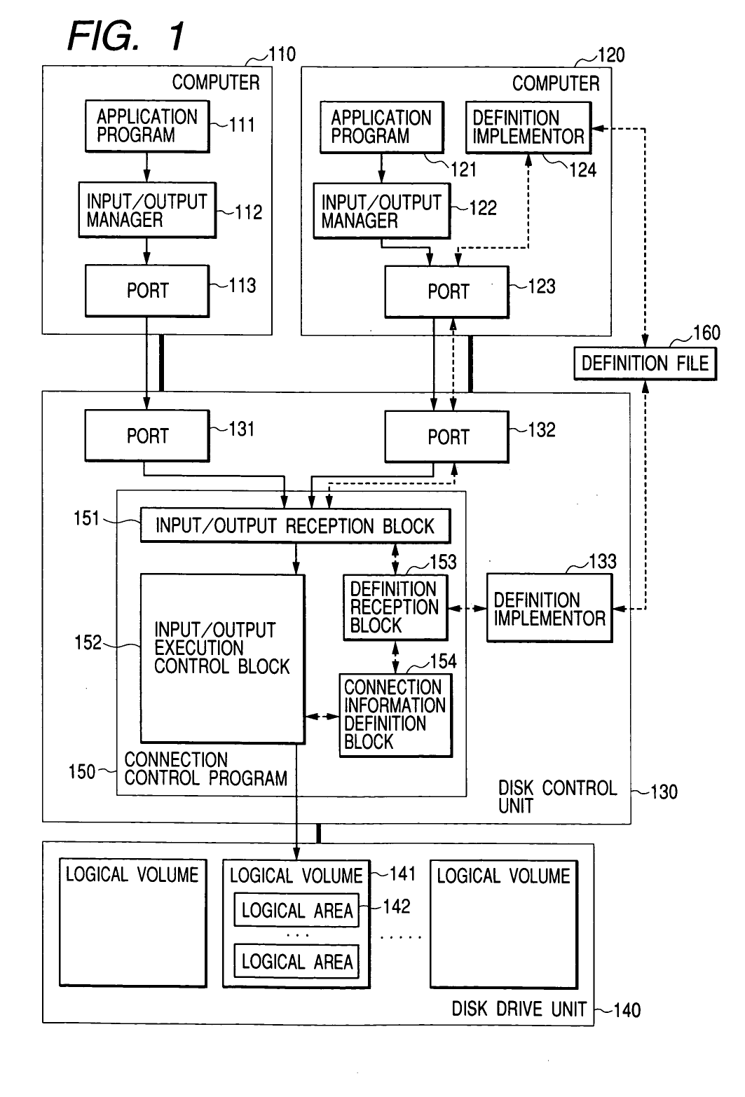

FIG. 1 shows the configuration of a computer system having an embodiment of an input/output management system in accordance with the present invention, and a disk device connected to the computer system. In the embodiment, the computer system comprises computers 110 and 120, and the disk device comprises a disk control unit 130 and a disk drive unit 140. The computers 110 and 120 include application programs 111 and 121 that run in the respective computers, and input/output managers 111 and 122 provided by the operating systems. Moreover, the computer 120 has a definition implementor 124. Ports 113 and 123 of the respective computers through which the computers are connected to the disk device include what are generally called channels and employed in a mainframe.

On the other hand, the disk control unit 130 comprises ports 131 and 132 through which the disk control unit is connected to the computers, a definition implementor 133, and a connection control program 150. The disk drive unit 140 includes logical volumes 141 each having a plurality of logical areas 142. The connection control program 150 has such facilities as an input/output reception block 151, an input/output execution control block 152, a definition reception block 153, and a connection information definition block 154. Needless to say, the disk control unit 130 includes a processor that runs the program, and a memory (not shown). Incidentally, the definition implementors 124 and 133 are connected to a definition file 160.

Next, flows of an input or output request (hereinafter an input/output request) from the computer system to the disk device in the present embodiment will be described below. Arrows written with sold lines in FIG. 1 indicate the flows of an input/output request to or from a logical volume, and arrows written with dot lines in FIG. 1 indicate the flows of definition information.

An input/output request issued from the application program 111 that runs in the computer 110 is transmitted to the disk device via the input/output manager 112 and port 113. The input/output request is then transmitted to the connection control program 150 residing in the disk control unit 130 via the port 131. The input/output reception block 151 included in the connection control program 150 first handles the input/output request. The input/output reception block 151 verifies based on the data appended to the input/output request whether the input/output request is concerned with a logical volume or definition information. If the input/output request is concerned with a logical volume, it is transmitted to the input/output execution control block 152. If the input/output request is concerned with definition information, it is transmitted to the definition reception block 153.

The input/output execution control block 152 having received the input/output request concerned with a logical volume references input/output request source computer identification information, object logical volume identification information, and object logical area identification information which are appended to the input/output request. The input/output execution control block 152 checks a connected state value concerning the connection of an input/output request source computer to an object logical volume or an object logical area which is retrieved from the connection information definition block 154. The input/output execution control block 152 then judges whether input or output (input/output) from or to the logical volume 141 or logical area 142 included in the disk drive unit 140 is enabled. If input/output is enabled, input/output from or to the object logical volume or logical area is executed. If input/output is disabled, input/output is not executed. In response to an input/output request for the input/output that is not executed, the input/output execution control block 152 transmits error information to the input/output reception block 151. The input/output reception block 151 reports the error to the input/output manager 112 included in the computer 110.

Connection information employed by the input/output execution control block 152 is transmitted as a kind of input/output request from the definition implementor 124 included in the computer 120 to the input/output reception block 151 via the ports 123 and 132. If the input/output reception block 151 judges that the input/output request is concerned with definition information, the input/output reception block 151 transmits the input/output request to the definition reception block 153. The definition reception block 153 specifies the connection information in the connection information definition block 154. Even when the computer 120 is not operated, the connection information can be specified in the connection information definition block 154 using the definition implementor 133 included in the disk control unit 130.

Furthermore, the connection information specified in the connection information definition block 154 may be recorded in the definition file 160 using the definition implementor 124 or 133. The connection information recorded in the definition file 160 may be specified in the connection information definition block 154 using the definition implementor 124 or 133.

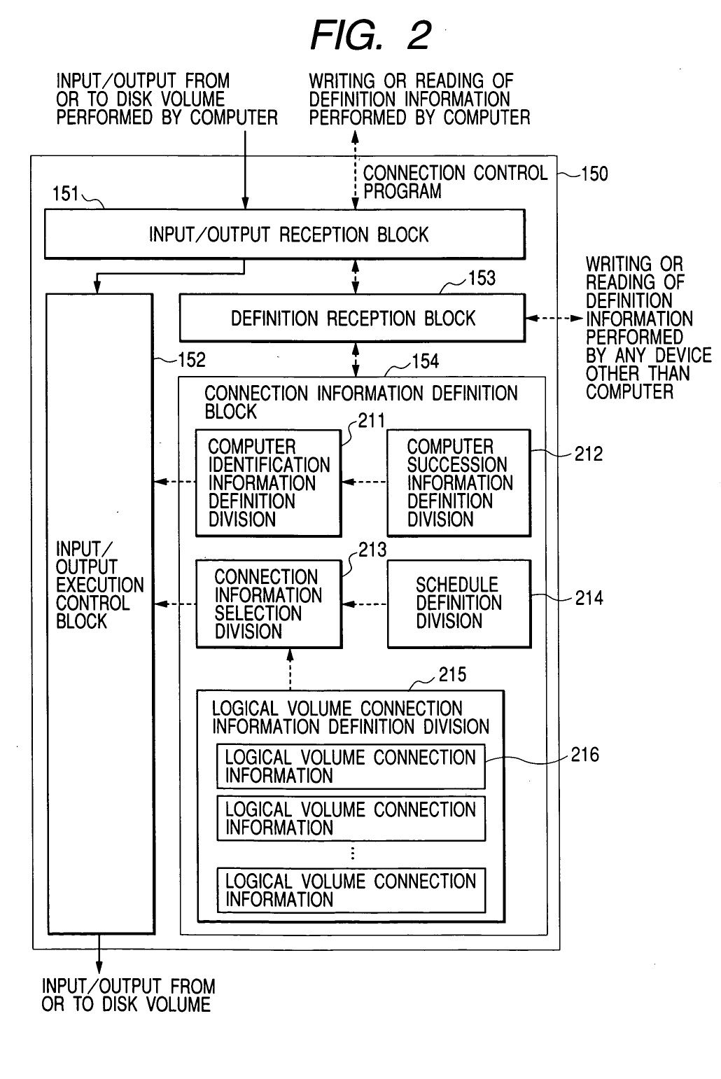

FIG. 2 is an explanatory diagram detailing the facilities of the connection information definition block 154 included in the connection control program 150. The connection information definition block 154 comprises a computer identification information definition division 211, a computer succession information definition division 212, a connection information selection division 213, a schedule definition division 214, and a logical volume connection information definition division 215.

In the computer identification information definition division 211, correspondence information is specified so that computer identification information appended to an input/output request can be converted into a computer number employed in the connection control program.

In the computer succession information definition division 212, correspondence information is specified in order to associate an operating computer with a successor computer on the assumption that an operating computer and a successor computer to which the operating computer is switched if the operating computer fails are physically connected to the disk device. If the connection control program 150 senses a failure of an operating computer, the connection control program 150 rewrites the contents of the computer identification information definition division 211 according to the contents of the computer succession information definition division 212. Consequently, logical volume connection information that has been provided for the operating computer can be used to handle an input/output request issued from a successor computer.

The connection information selection division 213 holds a logical volume connection information number that is currently selected from among numbers assigned to a plurality of pieces of logical volume connection information 216 specified in the logical volume connection information definition division 215. Logical volume connection information the input/output execution control block 152 actually uses to judge whether input/output is enabled is only logical volume connection information whose number is specified in the connection information selection division 213.

In the schedule definition division 214, a combination of a date and a logical volume connection information number that should be selected on the date is specified. When the specified date has come, a schedule in formation selection block writes an associated logical volume connection information number in the connection information selection division 213. Owing to the schedule definition division 214, appropriate logical volume connection information can be provided during each time zone according to a predefined schedule.

In the logical volume connection information definition division 215, one or a plurality of pieces of logical volume connection information 216 is specified. The logical volume connection information 216 contains a connected state value that is concerned with the connection of each computer indicated with a computer number to each logical volume or each logical area in a logical volume. The input/output execution control block 152 judges from the connected state value whether input/output is enabled. In the logical volume connection information definition division 215, a plurality of pieces of logical volume connection information 216 can be specified. The input/output execution control block 152 references logical volume connection information 216 assigned the same number as the number specified in the connection information selection division 213.

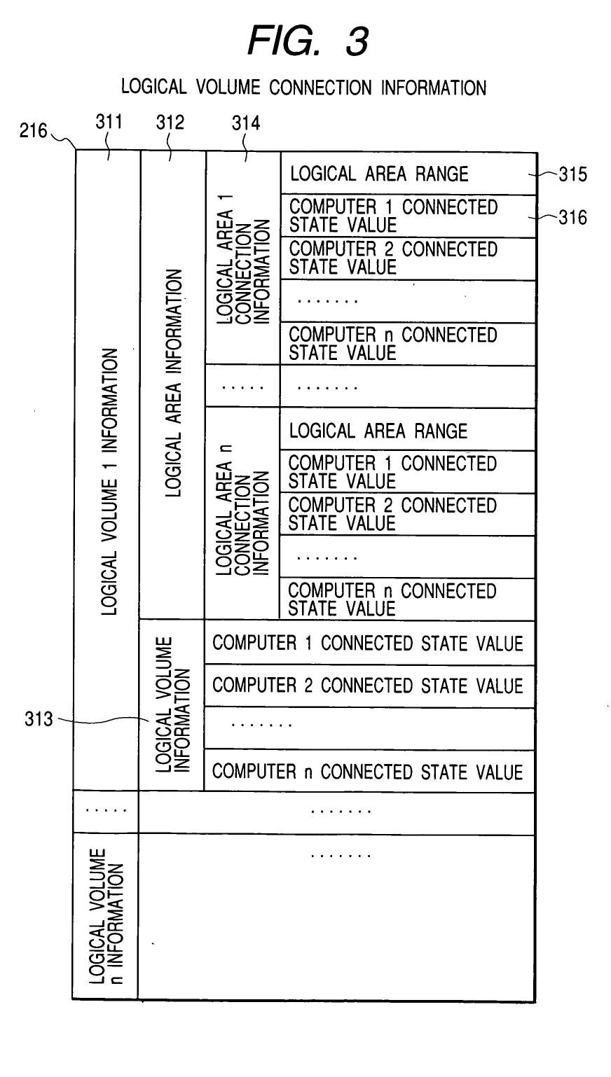

FIG. 3 is an explanatory diagram detailing the structure of the logical volume connection information 216. The logical volume connection information contains the same number of pieces of logical volume information 311 as the number of logical volumes included in the disk device. Each logical volume information 311 contains logical area information 312 and logical volume information 313.

The logical area information 312 contains pieces of logical area connection information 314 concerning specific areas in logical volumes. The logical area connection information 314 need not be specified in relation to each of the logical areas in all the logical volumes. Pieces of logical area connection information concerning logical areas in some of all the logical volumes may be specified. The contents of logical volume information 313 are adapted to logical areas relative to which logical area connection information is not specified in the logical area information 312.

The logical area connection information 314 contains a logical area range 315 and a computer connected state value 316. The logical area range 315 is information representing the range of a logical area, for example, information representing the start position of a logical area and the end position thereof, such as, a start block address and an end block address or a start cylinder address and an end cylinder address. The computer connected state value 316 is a value that is determined relative to each computer number specified in the computer identification in formation definition division 211 and that stipulates whether input/output requested by each computer is enabled.

The computer connected state value will be described below. This value has a certain range (for example, from 0 to 255). If the connected state value is set to a minimum value, input/output requested by a computer is disabled unconditionally. Namely, the minimum value signifies that the computer is fully disconnected. Moreover, if the connected state value is set to a maximum value, input/output requested by a computer is enabled unconditionally. Namely, the maximum value signifies that the computer is fully connected. An intermediate value between the minimum and maximum values signifies a conditionally connected state. In the conditionally connected state, assuming that an access key is appended to an input/output request, if the access key is equal to or smaller than the computer connected state value, input/output is enabled. If the access key is larger than the computer connected state value, input/output is disabled. If no access key is appended to an input/output request, the conditionally connected state is treated in the same manner as the fully disconnected state is. Input/output is disabled.

The logical volume information 313 contains a computer connected state value 316 concerning the connection of each computer to a logical volume. The computer connected state value 316 has already been described.

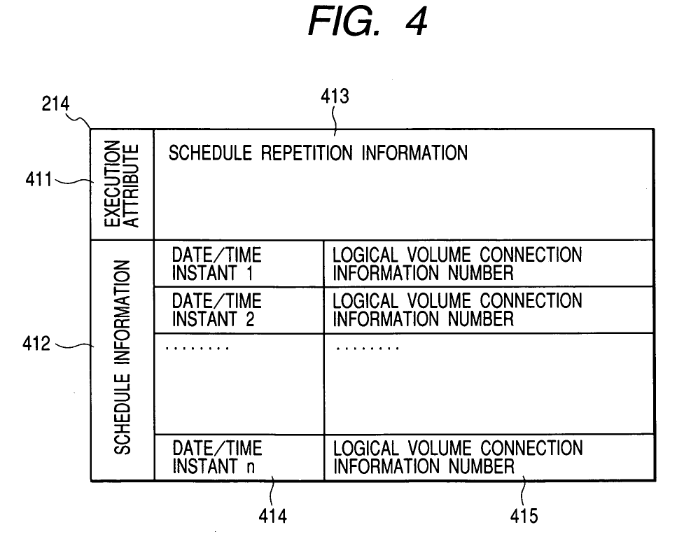

FIG. 4 is an explanatory diagram detailing the schedule definition division 214. The schedule definition division 214 contains an execution attribute 411 and schedule information 412.

The execution attribute 411 provides schedule repetition information 413. In the schedule repetition information 413, whether the contents of the schedule information 412 are performed repetitively is specified, and the unit of repetition is specified to be daily, weekly, or monthly. The schedule information 412 contains pairs of a date/time instant 414 and a logical volume connection information number 415. The pieces of information are entered in ascending order of date and time instant. The logical volume connection information number 415 is a number indicating one of the pieces of logical volume connection information 216 specified in the logical volume connection information definition division 215. When a date and a time instant specified as the date/time instant 414 associated with a logical volume connection information number 415 have come, the logical volume connection information number 415 is specified in the connection information selection division 213. As the date/time instant 414, a time instant in a day, a date and a time instant within a week, or a date and a time instant within a month may be specified. Whether a time instant in a day, a date and a time instant within a week, or a date and a time instant within a month is specified as the date/time instant 414 depends on the contents of the repetitive execution information 413.

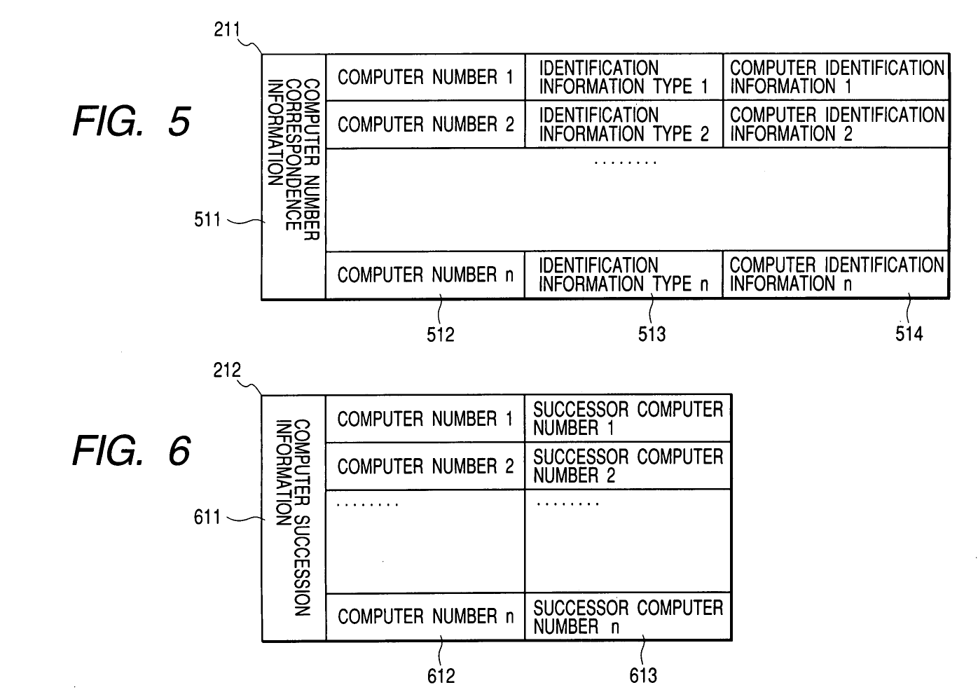

FIG. 5 is an explanatory diagram detailing the computer identification information definition division 211. In the computer identification information definition division 211, computer number correspondence information 511 is specified. The computer number correspondence information 511 comprises a computer number 512, an identification information type 513, and computer identification information 514. The computer number 512 is a number which the connection information definition block 154 uses to uniquely identify a computer. In the computer number correspondence information 511, the computer numbers are associated with the pieces of computer identification information 514 on a one-to-one basis.

The computer identification information 514 is physical identification information with which a computer connected to the disk device is uniquely identified. For example, a path group identifier employed in a mainframe or a worldwide name employed in a storage area network is adopted as the computer identification information. If identification information cannot be acquired from a computer, an address assigned to the port 131 of the disk device may be adopted. The identification information type 513 indicates which of the path group identifier and worldwide name is adopted as the computer identification information 514.

The same computer number 512 may be associated with a plurality of pieces of computer identification information 514. In this case, the plurality of computers may be divided into groups.

FIG. 6 is an explanatory diagram detailing the computer succession information definition division 212. Computer succession information 611 is specified in the computer succession information definition division 212. The computer succession information 611 comprises a computer number 612 and a successor computer number 613. When a computer identified with the computer number 612 is sensed to have failed, if any of the computer numbers 512 specified in the computer identification information definition division 211 is the same as the computer number 612, the computer number 512 is replaced with the associated successor computer number 613. Moreover, if any of the computer numbers 512 specified in the computer identification information definition division 211 is the same as the successor computer number 613, the computer number 512 is replaced with the associated computer number 612.

Consequently, the relationship of correspondence between the computer number 512 and computer identification information 513 specified in the computer identification information definition division 211 is varied depending on what computers are identified with the computer number 612 and successor computer number 613.

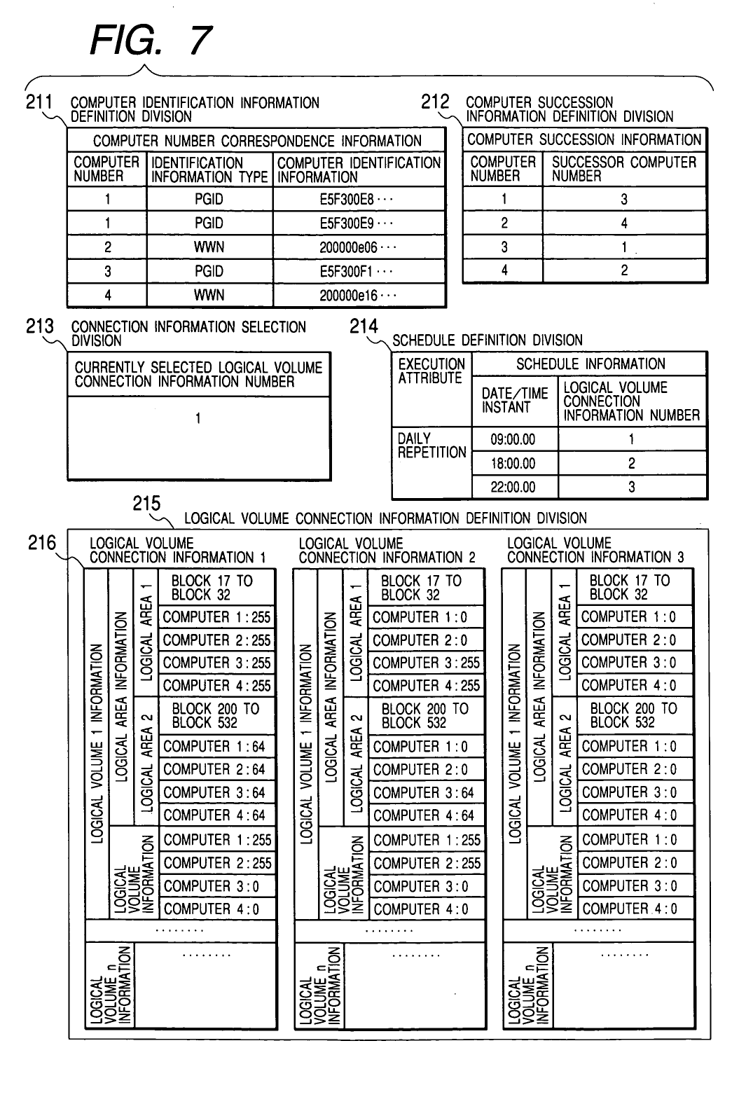

FIG. 7 shows concrete examples of computer identification information and logical volume connection information that are defined in the connection information definition block 154.

In the computer identification information definition division 211, four computers are defined. Computers bearing computer numbers 1 and 3 are mainframes, and the path group identifier (PGID) is adopted as identification information. Computers bearing computer numbers 2 and 4 are open systems, and the worldwide name (WWN) is adopted as identification information.

In the computer succession information definition division 212, the mainframes (computers 1 and 3) or the open systems (computers 2 and 4) are specified as successor computers of each other. The successor computers must be defined based on an actual operation form.

The contents of the connection information selection division 213 vary depending on the date/time instant according to the contents of the schedule definition division 214. Currently, logical volume connection information 1 is selected.

In the schedule definition division 214, schedule information is defined based on which of the computers is operated during what time zone. Since the daily operation schedule remains unchanged, daily repetition is designated as an execution attribute. The computers 1 and 2 perform online jobs from 9:00 to 18:00, the computers 3 and 4 perform batch jobs from 18:00 to 22:00, and the computers 3 and 4 perform development jobs from 22:00 to 8:00 in the next morning. Therefore, schedule information is defined in association with the three time zones.

In the logical volume connection information definition division 215, three pieces of logical volume connection information 216 are specified. These pieces of logical volume connection information are specified in association with the three operation time zones.

For example, a logical volume 1 is an online job volume. The logical volume connection information 1 specified relative to the online job time zone signifies that: the online job computers 1 and 2 alone are permitted to access the logical volume 1 (the connected state value is set to 255); but the batch job or development job computers 3 and 4 are not permitted to access the logical volume 1 (the connected state value is set to 0). However, a program having certain authority can access a special file alone irrespective of whether the program performs an online job or batch job (the connected state value is set to 64).

Moreover, the logical volume connection information 2 specified relative to the batch job time zone signifies that the batch job/development job computers 3 and 4 alone can access the logical volume 1. The logical volume connection information 3 specified relative to the development job time zone signifies that none of the computers is permitted to access the logical volume 1 that is an online job volume.

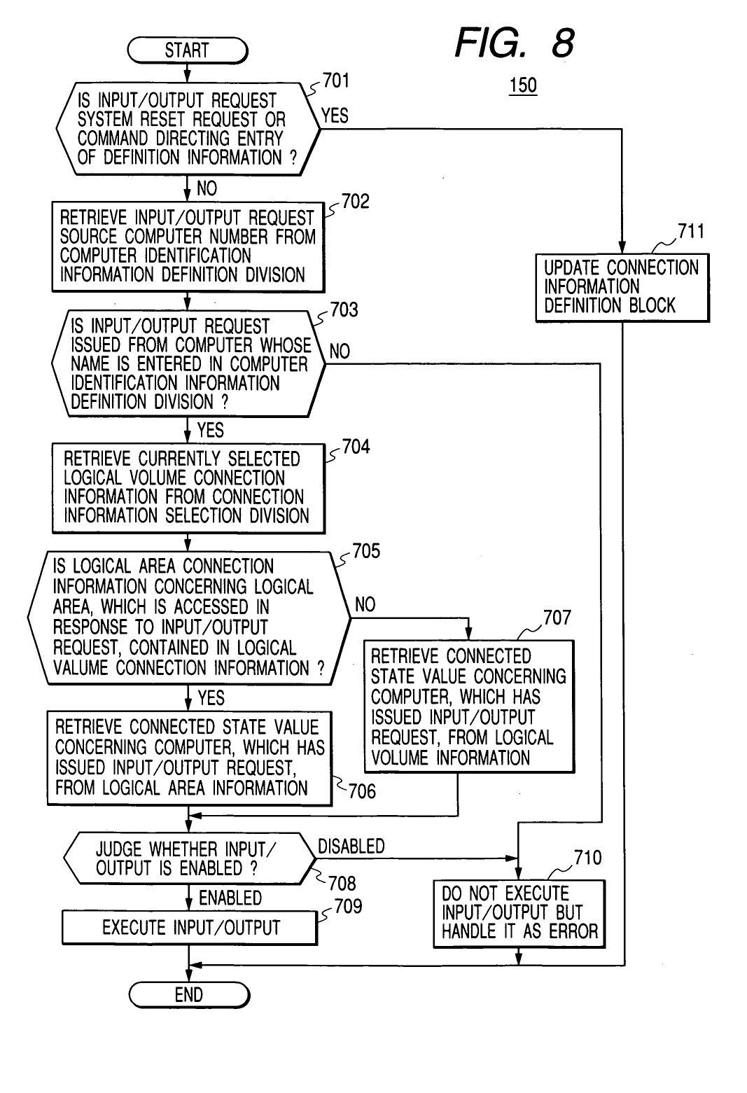

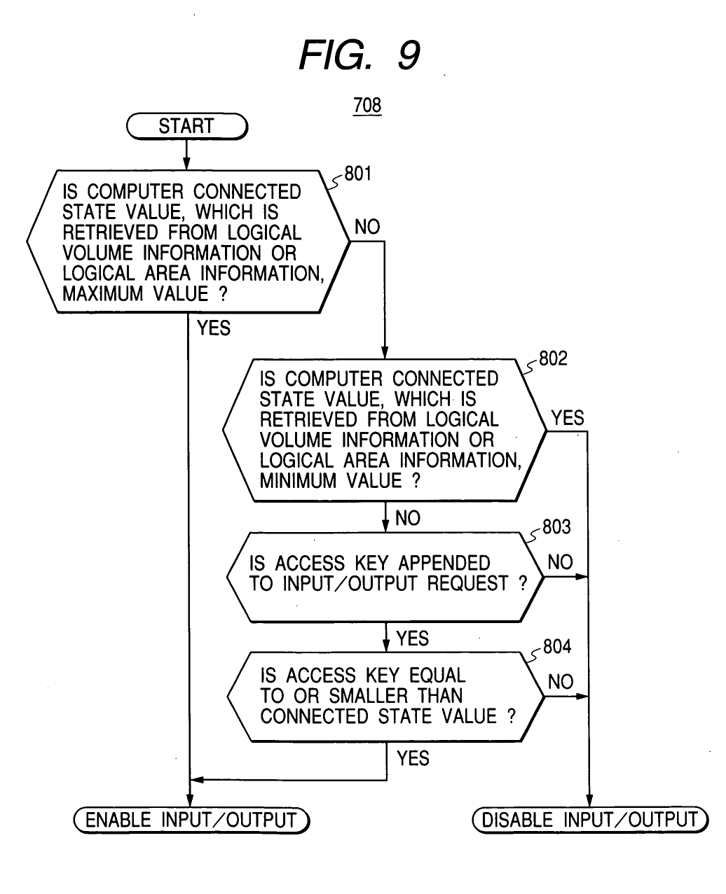

FIG. 8 is a flowchart describing a process of controlling input/output to be executed by running the connection control program 150.

The input/output reception block 151 receives an input/output request issued from the computer 110 or 120 via the port 131 or 132 of the disk control unit. The input/output reception block 151 verifies the kind of input/output request (step 701), and writes or reads definition information in or from the connection control program 150. If the input/output request is a system reset request attributable to the fact that a computer has failed, the input/output request is passed to the definition reception block 153 (step 711). If the input/output request is a request for reading or writing of data from or in the logical volume 141, the input/output request is passed to the input/output execution control block 152.

If the input/output request is passed to the input/output execution control block 152, the computer identification information definition division 211 is referenced based on the computer identification information 514 appended to the input/output request. Thus, the computer number 512 assigned to an input/output request source is retrieved (step 702).

Thereafter, whether the input/output request has been issued from a computer whose information is unspecified in the computer identification information definition division 211 is judged (step 703). If the input/output request is issued from the computer whose information is unspecified, whether input/output is enabled or disabled is not judged from the connection information definition block 154, and input/output is not executed. A report identical to the one sent when an input/output error occurs is transmitted to the request source (step 710).

On the other hand, if the input/output request is issued from the computer whose information is specified, the number assigned to the currently selected logical volume connection information 216 is retrieved from the connection information selection division 213 (step 704).

The logical volume connection information 216 bearing the same number as the one retrieved at step 704 is referenced in order to retrieve the logical volume information 311 on the basis of input/output object logical volume information appended to the input/output request. If the input/output request is concerned with access to a logical area in the logical volume, the relationship between the logical area connection information 314 and logical area range 315 is judged. Specifically, the logical area information 312 contained in the logical volume information 311 is referenced to search for the logical area connection information 314 that contains as the logical area range 315 the same logical area position information as the one appended to the input/output request (step 705).

If the logical area connection information 314 containing as the logical area range 315 the same logical area position information as the one appended to the input/output request is found, the computer connected state value 316 is retrieved from the logical area connection information 314 (step 706).

If the logical area connection information 314 containing as the logical area range 315 the same logical area position information as the one appended to the input/output request is unfound, or if the input/output request is not a request for access to a logical area in the logical volume, the computer connected state value 316 contained in the logical volume information 313 is retrieved (step 707).

The computer connected state value 316 retrieved at step 706 or step 707 is compared with an access key appended to the input/output request in order to judge whether input/output requested with the input/output request is enabled (step 708). Judging whether input/output is enabled will be detailed in conjunction with FIG. 9.

Input/output requested with the input/output request and judged to be enabled at step 708 is executed as it is (step 709).

Input/output requested with the input/output request and judged to be disabled at step 708 is not executed. The same report as the one sent when an input/output error occurs is transmitted to the request source (step 710).

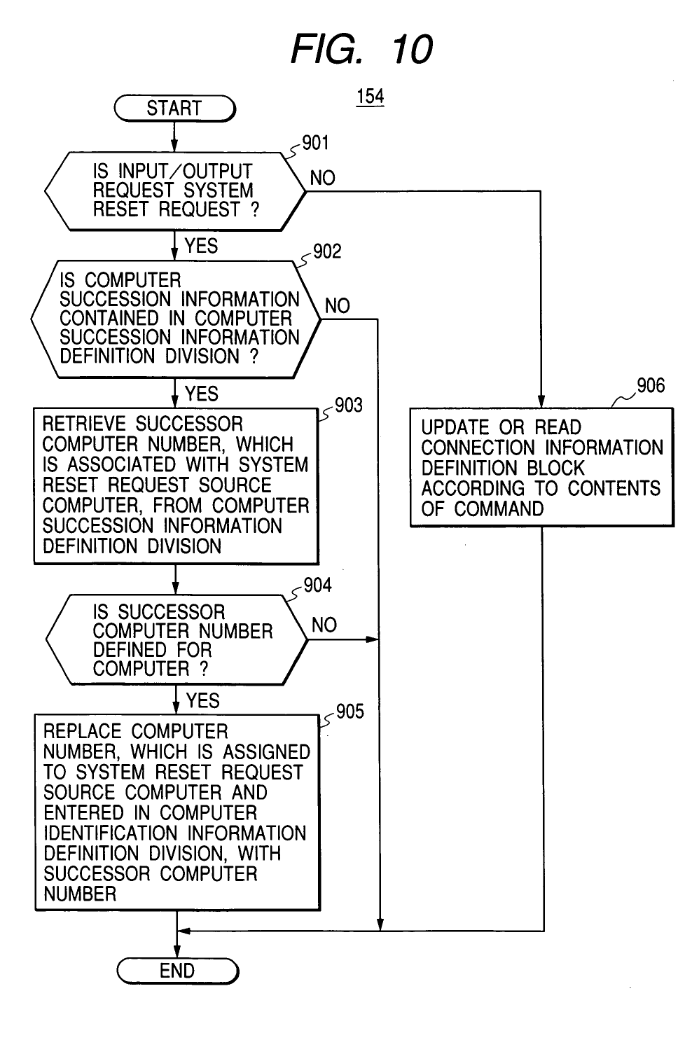

If the input/output request is a request for writing or reading of definition information in or from the connection control program 150 or a system reset request attributable to the fact that a computer has failed, the definition reception block 153 updates the connection information definition block 154 (step 711). Updating the connection information definition block 154 will be detailed in conjunction with FIG. 10.

FIG. 9 is a flowchart describing judgment of whether input/output is enabled (step 708 in FIG. 8).

If the computer connected state value 316 retrieved from the logical area information 312 at step 706 in FIG. 8 or the computer connected state value 316 retrieved from the logical volume information 313 at step 707 assumes the maximum value within the permissible range, the computer is regarded to be fully connected. Irrespective of a condition specified in the input/output request, input/output is judged to be enabled. If the computer connected state value 316 does not assume the maximum value, other verifications are performed (step 801).

If the computer connected state value 316 retrieved from the logical area information 312 at step 706 in FIG. 8 or the computer connected state value 316 retrieved from the logical volume information 313 at step 707 assumes the minimum value within the permissible range, the computer is regarded to be fully disconnected. Irrespective of a condition specified in the input/output request, input/output is judged to be disabled. If the computer connected state value 316 does not assume the minimum value, other verifications are performed (step 802).

If an access key is appended to the input/output request, the computer connected state value 316 is compared with the access key. If the access key is not appended to the input/output request, input/output is judged to be disabled (step 803).

After the computer connected state value 316 is compared with the access key appended to the input/output request, if the access key is found to be equal to or smaller than the computer connected state value 316, input/output is judged to be enabled. If the access key is larger than the computer connected state value 316, input/output is judged to be disabled (step 804).

FIG. 10 is a flowchart describing updating of the connection information definition block 154. First, a process is bifurcated depending on whether an input/output request is a system reset request or a command for writing or reading of the connection information definition division (step 901).

If the input/output request is a system reset request, unless the computer succession information 611 is specified in the computer succession information definition division 212, nothing is performed (step 902).

If the computer succession information 611 is specified in the computer succession information definition division 212, the successor computer number 613 associated with the computer number assigned to the system reset request source is retrieved (step 903).

If the successor computer number 613 associated with the computer number 612 assigned to the computer that is the system reset request source is not defined, nothing is performed (step 904).

If the successor computer number 613 associated with the computer number 612 assigned to the system reset request source computer is defined, the computer numbers 512 among those specified in the computer identification information definition division 211 which are identical to the computer number 612 are replaced with the associated successor computer number 613. If the computer numbers 512 specified in the computer identification information definition division 211 include the computer numbers 512 identical to the successor computer number 613, the computer numbers 512 are replaced with the computer number 612 (step 905).

If the input/output request is not the system reset request, the input/output request is a command directing updating or reading of the connection information definition block 154. Based on the contents of the command, the connection information definition block 154 is updated or read (step 906).

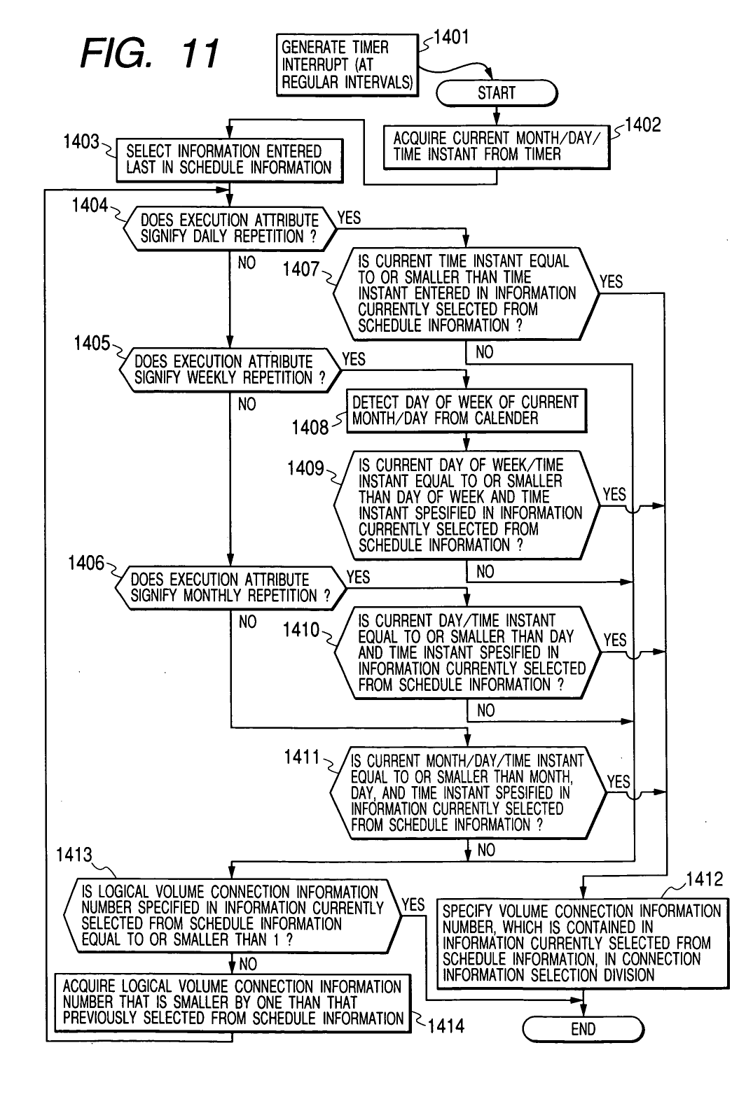

FIG. 11 is a flowchart describing a schedule control flow.

Schedule control is executed with a timer interrupt, which a built-in timer of the disk control unit 130 regularly generates, as a trigger on the basis of schedule information concerning the operation forms of the computers associated with different time zones which is defined in the schedule definition division 214 (step 1401).

First, a current month/day/time instant is read from the built-in timer (step 1402).

Among the pieces of information contained in the schedule information 412, information having the last entry number is selected (step 1403).

If the schedule repetition information 413 contained in the execution attribute 411 signifies daily repetition, the current month/day/time instant is compared with the information contained in the schedule information 412 in the fashion determined for daily repetition. If the schedule repetition information 413 does not signify daily repetition, whether the schedule repetition information 413 signifies weekly or monthly repetition is checked (step 1404).

If the schedule repetition information 413 contained in the execution attribute 411 signifies weekly repetition, the current month/day/time instant is compared with the information contained in the schedule information 412 in the fashion determined for weekly repetition. If the schedule repetition information 413 does not signify weekly repetition, whether the schedule repetition information 413 signifies monthly repetition is checked (step 1405).

If the schedule repetition information 413 contained in the execution attribute 411 signifies monthly repetition, the current month/day/time instant is compared with the information contained in the schedule information 412 in the fashion determined for monthly repetition. If the schedule repetition information 413 does not specify monthly repetition, the current month/day/time instant is compared with the information contained in the schedule information 412 with no consideration taken into what is specified for repetition (step 1406).

If the schedule repetition information 413 signifies daily repetition, month/day information is ignored. The current time instant is compared with the time instant specified in a selected date/time instant 414 contained in schedule information. If the comparison demonstrates that the current time instant is equal to the time instant specified in the selected date/time instant 414 contained in schedule information, or if the time instant specified in the selected date/time instant 414 contained in schedule information is larger, the connection information selection division 213 is updated. Otherwise, the current time instant is compared with the one specified in other selected date/time instant 414 contained in the schedule information 412 (step 1407).

If the schedule repetition information 413 signifies weekly repetition, the current day of the week is drawn out of the current month/day information and calendar information held in the disk control-unit 130 (step 1408).

With month/day information ignored, the current day of the week and time instant are compared with a day of the week and a time instant specified in the selected date/time instant 414 contained in schedule information. If the comparison demonstrates that the current day of the week and time instant are equal to the day of the week and the time instant specified in the selected date/time instant 414 contained in schedule information, or if the day of the week and the time instant specified in the selected date/time instant 414 contained in schedule information are larger, the connection information selection division 213 is updated. Otherwise, the current day of the week and time instant are compared with those specified in other date/time instant 414 contained in the schedule information 412 (step 1409).

If the schedule repetition information 413 signifies monthly repetition, month information is ignored, and the current day and time instant are compared with the day and time instant specified in a selected date/time instant 414 contained in schedule information. If the comparison demonstrates that the current day and time instant are equal to the day and time instant specified in the selected date/time instant 414 contained in schedule information, or if the day and time instant specified in the selected date/time instant 414 contained in the schedule information are larger, the connection information selection division 213 is updated. Otherwise, the current day and time instant are compared with those specified in other date/time instant 414 contained in the schedule information 412 (step 1410).

If the schedule repetition information 413 is not specified, the current month, day, and time instant are compared with the month, day, and time instant specified in the selected date/time instant 414 contained in the schedule information. If the comparison demonstrates that the current month, day, and time instant are equal to the month, day, and time instant specified in the selected date/time instant 414 contained in the schedule information, or if the month, day, and time instant specified in the selected date/time instant 414 contained in the schedule information are larger, the connection information selection division 213 is updated. Otherwise, the current month/day/time instant is compared with other date/time instant 414 contained in the schedule information (step 1411).

The connection information selection division 213 is updated by entering a logical volume connection information number, which is specified in the selected logical volume connection information number 415 contained in the schedule information, in the connection information selection division 213 (step 1412).

If the currently selected logical volume connection information number 415 contained in the schedule information 412 is equal to or smaller than 1, other logical volume connection information number 415 is not checked but processing is terminated. Only when the currently selected logical volume connection information number 415 is equal to or larger than 2, other logical volume connection information number 415 is checked (step 1413).

For checking, the currently selected logical volume connection information number 415 contained in the schedule information 412 is decreased by one, and an immediately preceding logical volume connection information number 415 is selected. Thereafter, what is specified in the schedule repetition information 413 is checked again, and comparison of a month, a day, and a time instant is repeated (step 1414).

According to the present embodiment, irrespective of which of various operation forms of a computer system is adopted, data stored in a disk device can be protected. Namely, a volume or a file accessible to each application program can be determined arbitrarily. Thus, user-friendliness is improved and data is protected at a required level.

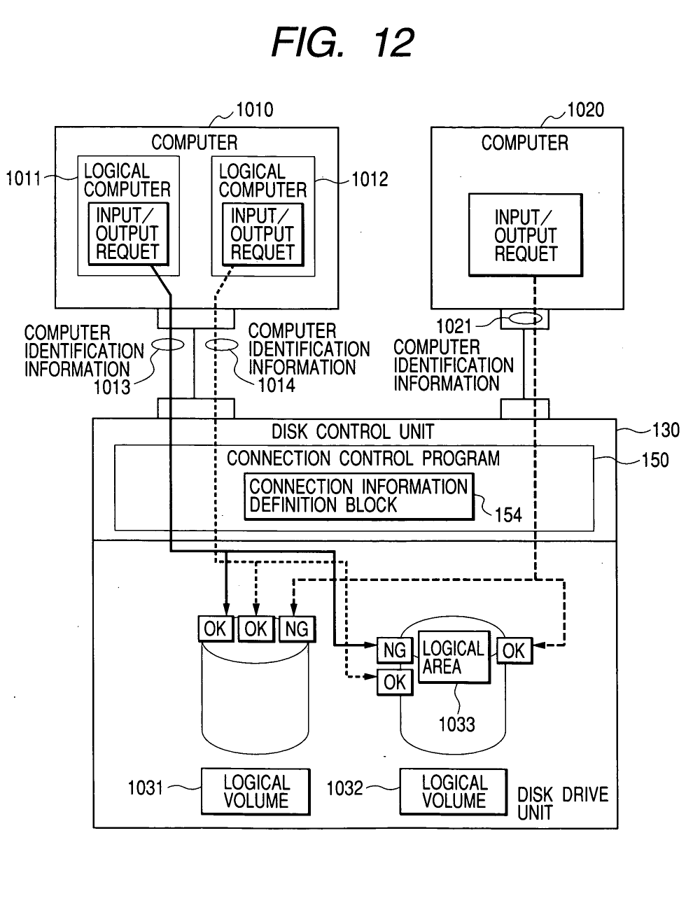

FIG. 12 shows an embodiment adapted to a case where input/output involves a disk device shared by three computers. FIG. 12 shows only the components relevant to the present embodiment on the assumption that the configuration of the present embodiment is fundamentally identical to that of the embodiment described in conjunction with FIG. 1 and FIG. 2. According to the present embodiment, whether input/output from or to a logical volume or a logical area in a logical volume, which is shared by the computers, requested by each of the computers is enabled is controlled in order to prevent data destruction caused by illegal input/output and to intensify data protection.

A computer 1010 shall be a mainframe and used while being divided into a logical computer 1011 and a logical computer 1012. When the logical computers issue an input/output request to a disk control unit 130, computer identification information 1013 or 1014, for example, a path group identifier is appended to the input/output request. The disk control unit 130 can therefore identify the computer serving as an input/output request source. The computer 1020 shall be an open-system workstation. When the computer 1020 issues an input/output request to the disk control unit 130, computer identification information 1021, for example, a worldwide name is appended to the input/output request. The disk control unit 130 can therefore identify the computer serving as an input/output request source.

According to the present embodiment, input/output requested by the logical computer 1011 or 1012, or the computer 1020 is executed by running the connection control program 150. Based on the contents of the connection information definition block 154, whether input/output from or to a logical volume or a logical area in a logical volume requested by each computer is enabled can be controlled. For example, input/output from or to a logical volume 1031 requested by the logical computer 1011 or 1012 may be enabled, but input/output therefrom or thereto requested by the computer 1020 may be disabled. Moreover, input/output from or to a logical area 1033 in the logical volume 1032 requested by the logical computer 1011 may be disabled, input/output therefrom or thereto requested by the logical computer 1012 may be enabled, and input/output therefrom or thereto requested by the computer 1020 may be enabled.

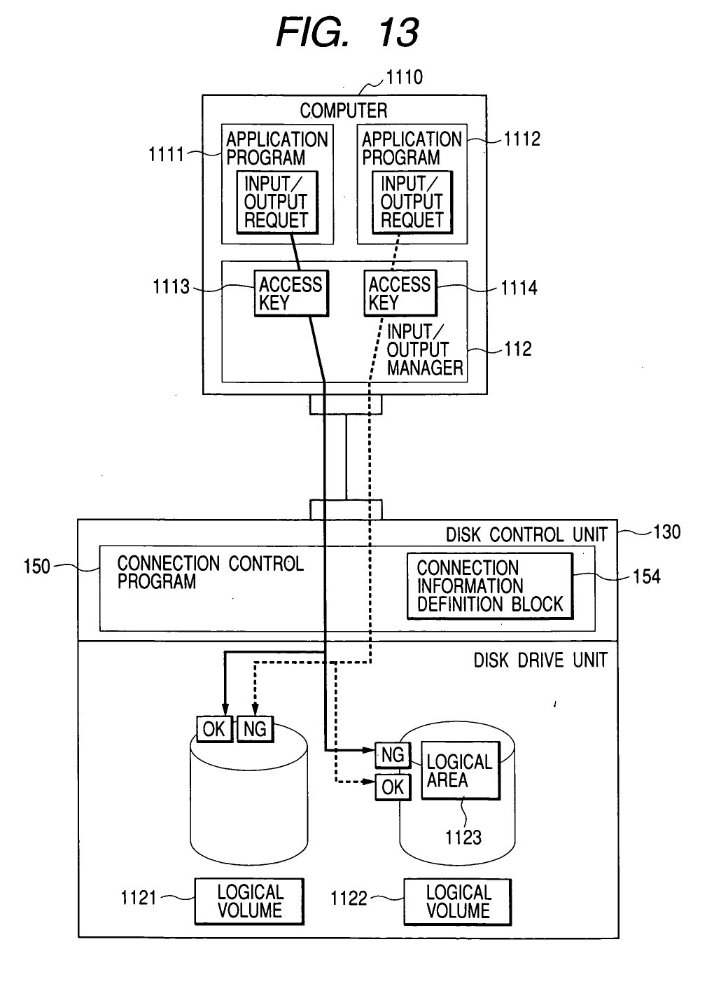

FIG. 13 shows an embodiment adapted to a case where a plurality of jobs being processed in one computer requests input/output from a disk device. FIG. 13 shows only the components relevant to the present embodiment on the assumption that the configuration of the present embodiment is fundamentally identical to the configuration shown in FIG. 1 and FIG. 2. According to the present embodiment, whether input/output from or to a logical volume or a logical area in the logical volume, which is shared by a plurality of programs running in one computer, requested by each program is enabled is controlled in order to prevent data destruction caused by illegal input/output and to intensity data protection.

An input/output manager 112 appends an access key 1113 or 1114 to an input/output request issued from a program 1111 or a program 1112 that is run in a computer 1110. Request source address space identification information is appended to the input/output request. The input/output manager 112 determines the value of the access key 1113 or 1114 on the basis of the address space identification information, and appends the access key to the input/output request.

According to the present embodiment, input/output requested by the program 1111 or 1112 is executed by running the connection control program 150. Based on the contents of the connection information definition block 154, whether input/output from or to a logical volume or a logical area in a logical volume requested by each program is enabled can be controlled. For example, input/output from or to a logical volume 1121 requested by the program 1111 may be enabled, but input/output therefrom or there to requested by the program 1112 may be disabled. Moreover, input/output from or to a logical area 1123 in a logical volume 1122 requested by the program 1111 may be disabled, but input/output therefrom or thereto requested by the program 1112 may be enabled.

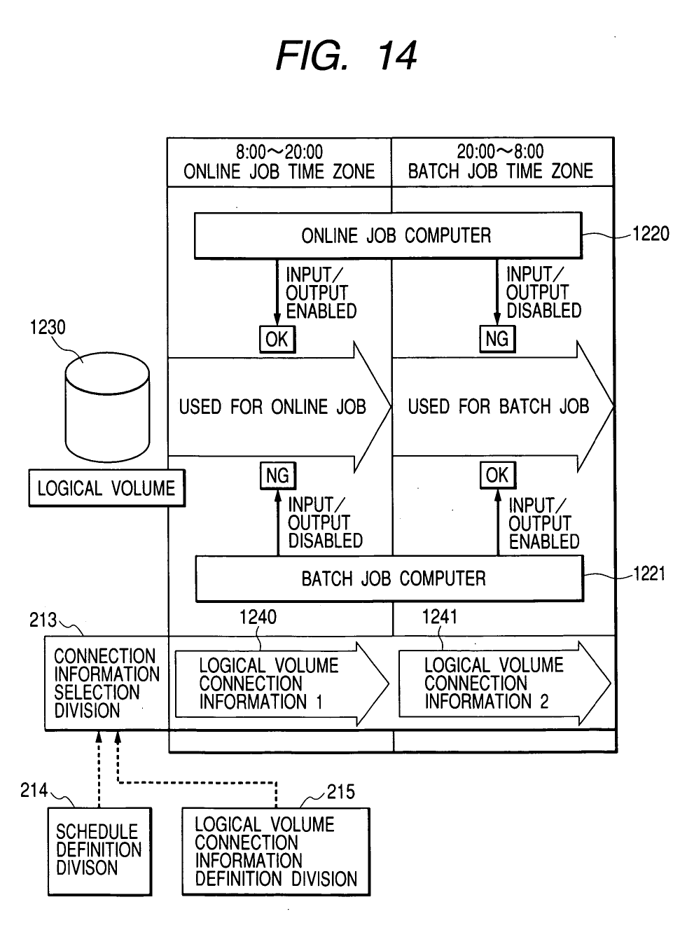

FIG. 14 shows an embodiment adapted to a case where whether input/output from or to a logical volume that is shared by two computers is enabled is automatically varied depending on a time zone. FIG. 14 shows only the components relevant to the present embodiment on the assumption that the configuration of the present embodiment is fundamentally identical to the one shown in FIG. 1 and FIG. 2. According to the present embodiment, whether input/output from or to a logical volume or a logical area in a logical volume, which is shared by two computers, requested by each computer is enabled is automatically varied depending on a time zone. Since the operation forms of the computer are switched with the start of each of the time zones, data destruction caused by illegal input/output can be prevented and data protection can be intensified.

An online job computer 1220 can use a logical volume 1230 during an online job time zone from 8:00 to 20:00, while a batch job computer 1221 can use the logical volume 1230 during a batch job time zone from 20:00 to 8:00. In this case, when it is 8:00 or later, a numeral indicating logical volume connection information 1 (1240) is specified in the schedule definition division 214. When it is 20:00 or later, a numeral indicating logical volume connection information 2 (1241) is specified therein. The above switching of the computers with the start of each of the time zones is defined so that it will be repeated daily. Moreover, the logical volume connection information 1 (1240) and logical volume connection information 2 (1241) are specified in the logical volume connection information definition division 215.

When the online job computer 1220 is in operation, the maximum value of the computer connected state value 316 is contained in the logical volume connection information 1 (1240) concerning the logical volume 1230. When the batch job computer 1221 is in operation, the minimum value of the computer connected state value 316 is contained therein. Moreover, when the online job computer 1220 is in operation, the minimum value of the computer connected state value 316 is contained in the logical volume connection information 2 (1241) concerning the logical volume 1230. When the batch job computer 1221 is in operation, the maximum value of the computer connected state value 316 is contained therein.

Based on the contents of the schedule definition division 214 and logical volume connection definition division 215, when it comes 8:00 every day, the numeral indicating the logical volume connection information 1 (1240) is specified in the connection information selection division 213. When it comes 20:00, the numeral indicating the logical volume connection information 2 (1241) is specified in the connection information selection division 213. Consequently, during the online job time zone from 8:00 to 20:00, input/output from or to the logical volume 1230 requested by the online job computer 1220 is enabled. During the batch job time zone from 20:00 to 8:00, input/output therefrom or thereto requested by the batch job computer 1221 is enabled.

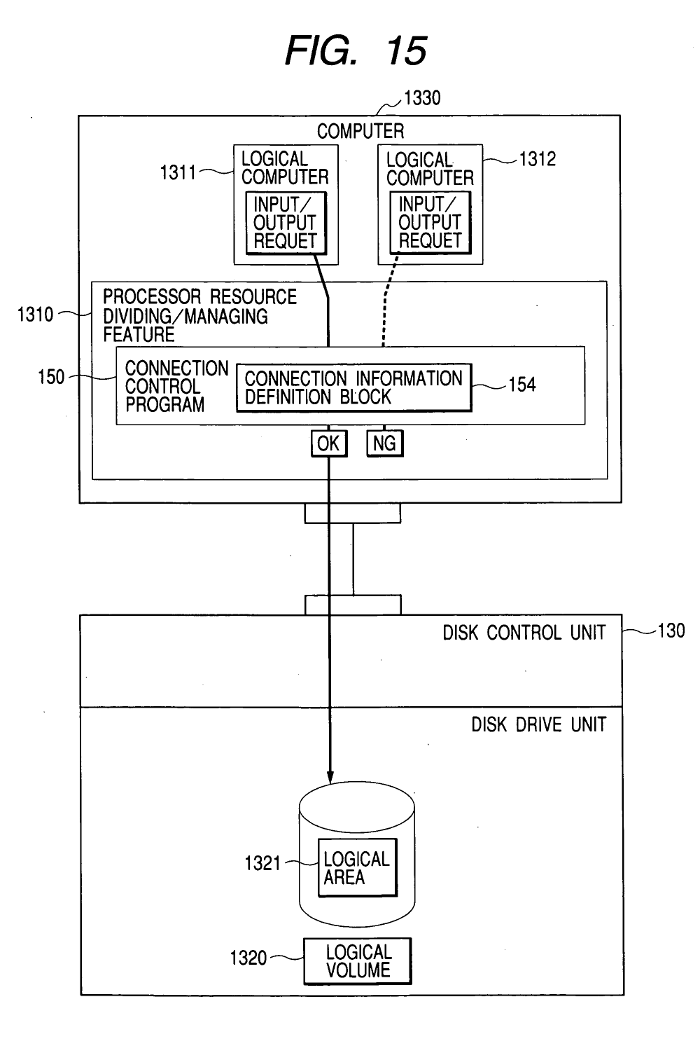

FIG. 15 shows an embodiment adapted to a case where the connection control program 150 is installed in a computer. FIG. 15 shows only the components relevant to the present embodiment on the assumption that the configuration of the present embodiment is identical to the one shown in FIG. 1 and FIG. 2. According to the present embodiment, the connection control program 150 installed in a processor resource dividing/managing feature 1310 is used to control whether input/output from or to a logical volume 1320 or a logical area 1321 in a logical volume, which is shared by the logical computers 1311 and 1312, requested by each of logical computers 1311 and 1312 is enabled. Consequently, data protection can be intensified during input/output from or to a disk control unit 130 devoid of the connection control program.

1. An input/output management system for managing input or output from or to a disk device connected to a computer, comprising:
a connection information definition block in which the relationship of logical connection between said computer and a logical volume included in said disk device or a logical area in a logical volume is defined; and
an input/output execution control block that controls, based on the definition, whether said computer can access a logical volume included in said disk device or a logical area in a logical volume.

2. An input/output management system for managing input or output from or to a disk device connected to a plurality of computers, comprising:
a connection information definition block in which the relationship of logical connection between each of said computers and a logical volume included in said disk device or a logical area in a logical volume is defined using computer identification information; and
an input/output execution control block that controls, based on the definition, whether each of said computers can access a logical volume included in said disk device or a logical area in a logical volume.

3. An input/output management system according to claim 1, wherein said connection information definition block comprises:
a computer identification information definition division in which physical identification information that uniquely indicates said computer connected to said disk device is defined; and
a logical volume connection information specification division in which a connected state value concerning the connection of said computer is specified in relation to each logical volume included in said disk device or each logical area in each logical volume.

4. An input/output management system for managing input or output from or to a disk device connected to a computer according to claim 1, wherein said connection information definition block comprises:
a computer identification information definition division in which the relationship of logical connection between said computer and a logical area in a logical volume included in said disk device is defined using computer identification information; and
a logical volume connection information specification division in which a connected state value concerning the connection of said computer is specified in relation to each logical area in each logical volume included in said disk device.

5. An input/output management system according to claim 4, wherein
said computer includes a plurality of logical computers,
computer identification information concerning each of said logical computers is specified in said computer identification information definition division, and
said input/output execution control block controls whether each of said logical computers that share the same physical input/output path can access a logical area in a logical volume included in said disk device.

6. An input/output management system according to claim 1, wherein said connection information definition block comprises:
a computer identification information definition division in which the relationship of logical connection between said computer and a logical volume included in said disk device is defined using port numbers assigned to the ports of said disk device connected to said computer; and
a logical volume connection information specification division in which a connected state value concerning the connection of said computer is specified in relation to each logical area in each logical volume included in said disk device.

7. An input/output management system for managing input or output from or to a disk device connected to a computer according to claim 1,
wherein the definition is used to control whether each of application programs running in said computer can access a logical volume included in said disk device or a logical area in a logical volume.

8. An input/output management system according to claim 7, further comprising a schedule definition division in which a plurality of pieces of computer identification information that defines whether said computer or each of said application programs can access a logical volume included in said disk device or a logical area in a logical volume is specified in relation to respective time zones, and in which a schedule for automatically changing the plurality of pieces of computer identification information is predefined.

9. An input/output management method for managing input or output from or to a disk device connected to a computer, comprising the steps of:
defining the relationship of logical connection between said computer and a logical volume included in said disk device or a logical area in a logical volume; and
controlling, based on the definition, whether said computer can access a logical volume included in said disk device or a logical area in a logical volume.

10. An input/output management method according to claim 9,
wherein the definition of the relationship of connection contains physical identification information that uniquely indicates said computer connected to said disk device, and also contains logical volume connection information that contains a connected state value concerning the connection of said computer to each logical volume included in said disk device or each logical area included in each logical volume.

11. An input/output management method form an aging input or output from or to a disk device connected to a computer, comprising the steps of:
defining, based on computer identification information and logical volume connection information, the relationship of logical connection between said computer and a logical volume included in said disk device or a logical area in a logical volume; and
controlling, based on the definition, whether said computer can access a logical area in a logical volume included in said disk device.

12. An input/output management method according to claim 9, wherein whether each of application programs running in said computer can access a logical volume included in said disk device or a logical area in a logical volume is controlled.

13. An input/output management method according to claim 11, wherein a plurality of pieces of definition information that defines whether said computer or each of application programs running in said computer can access a logical volume included in said disk device or a logical area in a logical volume is automatically switched with the start of each of time zones according to a predefined schedule.

14. An input/output management method according to claim 10,
wherein definition information that defines whether said computer or each of application programs running in said computer can access a logical volume included in said disk device or a logical area in a logical volume is automatically modified with a system failure occurring in said connected computer as a trigger.

15. A disk control program for implementing a method of processing information based on which input or output from or to a disk device connected to a computer is managed, wherein said method comprises the steps of:
defining the relationship of logical connection between said computer and a logical volume included in said disk device or a logical area in a logical volume on the basis of both physical identification information that uniquely indicates said computer connected to said disk device, and logical volume connection information that contains a connected state value concerning the connection of said computer to each logical volume included in said disk device or each logical area in each logical volume; and
controlling, based on the definition, whether said computer can access a logical volume included in said disk device or a logical area in a logical volume.
